(19) United States
(12) Patent Application Publication
(10) Pub. No.: US 2009/0116771 A1
(43) Pub. Date: May 7, 2009

(54) LUBRICANT COMPOSITION, BEARING OIL AND BEARING USING SAME

(75) Inventors: Hideto Kamimura, Chiba (JP); Katsumi Hashimoto, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu kosan co. Ltd, Chiyoda-ku Tokyo (JP)

(21) Appl. No.: 12/093,723

(22) PCT Filed: Nov. 15, 2006
(86) PCT No.: PCT/JP2006/322711

§ 371 Date: May 15, 2008

(30) Foreign Application Priority Data
Nov. 15, 2005 (JP) 2005 330827

(51) Int. Cl. F16C 32/06; C10M 107/02; C10M 169/04

(52) U.S. Cl. 384/100; 585/7; 585/1; 508/110

(57) ABSTRACT

Disclosed is a lubricant composition comprising a base oil which contains 50% by mass or more of at least one of an α-olefin oligomer and a hydrogenated product of an α-olefin oligomer and in which the kinematic viscosity and the flash point satisfy the following relational equation (I):

Flash point (° C.)≧49×ln γ+90 (I)

[provided that γ is a kinematic viscosity at 40° C.].

The lubricant composition contains a base oil which has little effect on a resin or elastomer because it is a nonpolar compound, in addition to having an extremely small amount of evaporation and a high flash point despite a low viscosity, and is suitable for various applications, in particular, as bearing oils.

### TECHNICAL FIELD

The present invention relates to a lubricant composition, a bearing oil, and a bearing and a rotary apparatus using thereof. More particularly, the present invention relates to a lubricant composition especially preferable as a bearing oil, which contains a base oil containing as a main component an α-olefin oligomer or a hydrogenated product thereof that has little effect on a resin or elastomer because it is a nonpolar compound, in addition to an extremely small amount of evaporation and a high flash point despite a low viscosity, and is used for, for example, oil hydraulics, turbines, machine tools, bearings, gears, metal processing and the like, and in particular to a bearing and a rotary apparatus using the lubricant composition.

### BACKGROUND ART

In general, a lubricant may cause deterioration of low temperature startability and decrease in the power efficiency when the base oil has too high a viscosity. On the contrary, a lubricant may cause increase in the oil consumption and the bearing damage due to insufficient lubricity when the base oil has a too low viscosity. The pour point of the base oil, which is an index of low temperature fluidity, is not specifically limited but preferably is −20° C. or lower.

As a synthetic lubricant, a poly-α-olefin is frequently used from the viewpoint of the low viscosity, thermal stability or oxidation stability although it has drawbacks and advantages depending on the intended use. However, a conventional poly-α-olefin contains a large number of isomers even in saturated aliphatic hydrocarbon compounds having the same molecular weight, and a specific component (isomer) may not be taken out by a purification method such as distillation and the like. For this reason, even a synthetic oil having a predetermined viscosity turns into a mixture of an easily volatile component and a less-volatile component. When such a saturated aliphatic hydrocarbon compound mixture is used as a lubricant, the easily volatile component is first evaporated, and the viscosity of the lubricant is increased during the operation of a machine.

Incidentally, the rotation speed of spindle motors used in electric equipments, especially CD, DVD, HDD, polygon scanner and the like increases year by year, and a high speed rotation of 10000 rpm or more has been currently required.

Conventionally, rolling bearings represented by ball bearings have been used in these spindle motors, however, noncontact fluid dynamic bearings and low cost sintered oil retaining bearings have been used from the viewpoint of performance and cost. The performance (mainly rotational torque) of these fluid dynamic bearings and sintered oil retaining bearings at high speed rotation is frequently determined by the viscosity of a lubricant used, and as the viscosity is decreased, the rotational torque at high speed rotation tends to decrease.

Once the lubricant is enclosed in a bearing mechanism, the lubricity is required to be maintained for life without resupplies, and thus the evaporation loss and decomposition loss of the lubricant should be avoided as much as possible.

In a hydrocarbon base oil represented by a usual mineral oil, when it is modified to have a low viscosity (low molecular weight), the evaporation loss is increased and it is difficult to achieve both low viscosity and low evaporation of the oil. In addition, in order to achieve both of these goals, there is known a technique in which an ester that is a polar compound is used as a base oil.

However, the use of a polar substance such as an ester causes a problem of deforming and discoloring various resin materials, for example, a coating material of a CD and DVD disk and the like and a constituent material of a motor frame and the like. Especially in the case of a CD and DVD on which recording is performed by optical signals, it should be avoided as much as possible that a coating material resin is optically clouded and deformed.

From these points of view, there is a circumstance where an ester-based oil having excellent properties may not be practically used. On the contrary, for a CD, DVD and motor equipment in which resin materials are frequently used, there has been conventionally used a lubricant containing as a base oil a poly-α-olefin which is less volatile than a mineral oil and is excellent in heat resistance.

As the poly-α-olefin, currently there has been widely used one that is obtained by oligomerizing an α-olefin by cationic polymerization using a BF₃ catalyst and further followed by hydrogenation. However, the molecular weight distribution of an oligomer may not be controlled by this production method and numerous isomers are generated even in the compounds having the same degree of polymerization. Therefore, as the product obtained by oligomerizing an α-olefin with a BF₃ catalyst is difficult to be purified and may have a wide range of the boiling point, it has a defect such as a large evaporation loss, and the like.

For example, there is disclosed a hydrogenated product of a decene trimer obtained by using a BF₃ catalyst (for example, see Patent Document 1). However, this compound has a low flash point despite having a high viscosity.

On the other hand, there is disclosed a technique in which a decene oligomer having a number average molecular weight of 500 to 200000 is produced using a metallocene catalyst and is subsequently hydrogenated where necessary, as a base oil for a lubricant (for example, see Patent Document 2). However, the decene oligomer has a large carbon number of approximately 35 to 1430 and is difficult to be used especially for fluid dynamic bearings and oil retaining bearings as a base oil because of the too high viscosity.

Patent Document 1: Japanese Patent Laid-Open Publication No. H10-504326

Patent Document 2: Japanese Patent Laid-Open Publication No. 2002-518582

### DISCLOSURE OF THE INVENTION

Under these circumstances, an object of the present invention is to provide a lubricant composition especially preferable as a bearing oil, which contains a base oil that has little effect on a resin or elastomer because it is a nonpolar compound, in addition to having an extremely small amount of evaporation and a high flash point while having a low viscosity, and is used for, for example, oil hydraulics, turbines, machine tools, bearings, gears, metal processing and the like, a bearing and a rotary apparatus using the lubricant composition.

The present inventors have made earnest studies with a view to developing a lubricant composition having the above-mentioned preferable properties and have found that the objectives can be achieved by using a base oil which contains as a main component an α-olefin oligomer obtained by using especially a metallocene catalyst and its hydrogenated product and in which the kinematic viscosity and the flash point satisfy a specific relationship. The present invention has been completed based on such findings.

That is, the present invention provides:

(1) a lubricant composition comprising a base oil containing 50% by mass or more of at least one of an α-olefin oligomer and a hydrogenated product of an α-olefin oligomer and having a kinematic viscosity and a flash point satisfying the following equation (I)

Flash point (° C.)≧49×ln γ+90 (I)

wherein γ is a kinematic viscosity (mm²/s) at 40° C.;

(2) the lubricant composition described in the above (1), wherein the α-olefin oligomer has a structure represented by the following general formula (II):

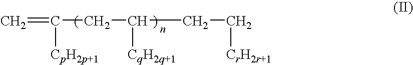

wherein p, q and r are each independently an integer of 0 to 18; n is an integer of 0 to 8; when n is 2 or more, q may be the same or different for every repeating unit; and a value of p+n×(2+q)+r is 12 to 36, and the hydrogenated product of an α-olefin oligomer has a structure represented by the following general formula (III):

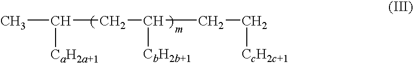

wherein a, b and c are each independently an integer of 0 to 18; m is an integer of 0 to 8; when m is 2 or more, a may be the same or different for every repeating unit; and a value of a+m×(2+b)+c is 12 to 36;

(3) the lubricant composition described in the above (1), wherein the base oil has a kinematic viscosity of 8 to 17 mm²/s at 40° C.;
(4) the lubricant composition described in the above (1), wherein the α-olefin oligomer is an oligomer having 24 to 30 carbon atoms obtained by using a metallocene catalyst and the hydrogenated product of the α-olefin oligomer is a product obtained by hydrogenating an α-olefin oligomer having 24 to 30 carbon atoms obtained by using a metallocene catalyst;
(5) the lubricant composition described in the above (1) containing at least one kind selected from an extreme pressure agent, an oiliness improver, an antioxidant, a rust inhibitor, a metal deactivator, a detergent-dispersant and an antifoaming agent;
(6) the lubricant composition described in the above (1) used for an oil hydraulics, a turbine, a machine tool, a bearing, a gear, or a metal processing;
(7) a bearing oil comprising a lubricant composition described in the above (1);
(8) a bearing comprising the bearing oil described in the above (7);
(9) the bearing described in the above (8), wherein the bearing is a fluid dynamic bearing, an oil retaining bearing, or an oil retaining bearing provided with a dynamic groove; and
(10) a rotary apparatus comprising a bearing unit having the bearing described in the above (8).

The present invention provides a lubricant composition especially preferable as a bearing oil, which contains a base oil containing as a main component an α-olefin oligomer or its hydrogenated product that have little effect on a resin or elastomer because it is a nonpolar compound, in addition to having an extremely small amount of evaporation and a high flash point despite a low viscosity, and is used for, for example, oil hydraulics, turbines, machine tools, bearings, gears, metal processing and the like.

In addition, the present invention provides a bearing oil containing the above-described lubricant composition, bearings that use the bearing oil such as fluid dynamic bearings, oil retaining bearings, and oil retaining bearings on which dynamic grooves are formed, and a rotary apparatus such as an electric motor equipped with a bearing unit having the above-described bearings.

### BRIEF DESCRIPTION OF THE DRAWINGS

FIG. 1 is an enlarged cross-sectional view illustrating an example of a spindle motor to which the lubricant composition of the present invention is applied.

### EXPLANATION OF THE SYMBOLS

1: Housing holder
2: Cylindrical section
3: Bearing
4: Inside relief
5: Motor shaft
6: Retaining member
7: Rotor
8: Magnet
9: Stacked core
10: Coil
11: Turn table
B: Base
M: Rotating medium

### BEST MODE FOR CARRYING OUT THE INVENTION

In a lubricant composition of the present invention, used is a base oil containing at least one of an α-olefin oligomer and a hydrogenated product of an α-olefin oligomer in an amount of 50% by mass or more, preferably 70% by mass or more, more preferably 80% by mass or more, further more preferably 90% by mass or more and especially preferably 100% by mass.

In the base oil, the kinematic viscosity and the flash point are required to satisfy the relationship of the following equation (I):

Flash point (° C.)≧49×ln γ+90 (I)

[wherein γ is a kinematic viscosity (mm²/s) at 40° C.].

When the flash point is lower than a value of “49×ln γ+90” (γ is the same as above), the base oil has a large amount of evaporation to occur and a low flash point at the kinematic viscosity required, and therefore the objective of the present invention may not be attained.

As the base oil, preferably, it is desirable that the kinematic viscosity and the flash point satisfy the following equation (I-a).

Flash point (° C.)≧49×ln γ+95 (I-a)

More preferably, it is desirable that the kinematic viscosity and the flash point satisfy the following equation (I-b).

Flash point (° C.)≧49×ln γ+100 (I-b)

In the base oil, the kinematic viscosity at 40° C. is preferably in the range of 8 to 17 mm²/s. If the kinematic viscosity is within the above range, the base oil has a low viscosity and is less volatile, and when used, for example, as a bearing oil, the rotational torque at high-speed rotation is low and the amount of evaporation is small even when used under a high temperature environment, the problem of the deficiency in the amount of oil hardly occurs. A preferred kinematic viscosity at 40° C. is 10 to 15 mm²/s. In addition, the flash point is preferably 200° C. or higher, more preferably 210° C. or higher and further more preferably 220° C. or higher. If the flash point is 200° C. or higher, the amount of the base oil reduced by evaporation during the use becomes small and the lifetime is prolonged.

Here, the kinematic viscosity is a value measured in accordance with JIS K2283 and the flash point is a value measured by a COC method in accordance with JIS K2265.

An α-olefin oligomer used for the base oil typically has a structure having a vinylidene bond at the terminal of the molecule represented by the following general formula (II).

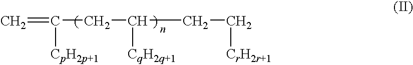

In the general formula (II), p, q and r are each independently an integer of 0 to 18; n is an integer of 0 to 8; when n is 2 or more, q may be the same or different for every repeating unit; and a value of p+n×(2+q)+r is 12 to 36.

In the present invention, the α-olefin oligomer may be used singly or in a combination of two or more kinds thereof.

In addition, a hydrogenated product of the α-olefin oligomer used for the base oil typically has a structure represented by the following general formula (III).

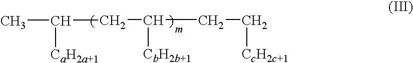

In the general formula (III), a, b, c and m are the same as p, q, r and n in the general formula (II) respectively.

In the present invention, the hydrogenated product of the α-olefin oligomer may be used singly or in a combination of two or more kinds thereof. Further, one or more kinds of the above-described α-olefin oligomers and one or more kinds of the above-described hydrogenated products of the α-olefin oligomer may be used in combination. From the aspect of oxidation stability and the like, the hydrogenated product of the α-olefin oligomer is more suitable than the α-olefin oligomer having a vinylidene bond at the terminal of the molecule.

In the present invention, in order to obtain a base oil satisfying the equation (I) of the above-described kinematic viscosity and flash point, the α-olefin oligomer represented by the general formula (II) is preferably an oligomer having 24 to 30 carbon atoms obtained by using a metallocene catalyst and the hydrogenated product of an α-olefin oligomer is preferably a product obtained by hydrogenating an α-olefin oligomer having 24 to 30 carbon atoms obtained by using a metallocene catalyst.

In the case where an α-olefin oligomer is oligomerized by using BF₃ which has been conventionally known as an oligomerization catalyst of an α-olefin, multiple isomers are generated even in the compounds having the same degree of polymerization and the isomers are difficult to be purified. Since the resulting α-olefin oligomers and their hydrogenated products may have a wide range of the boiling point, the evaporation loss during the use at a high temperature is large and the object of the present invention is difficult to be attained.

In the present invention, as the α-olefin which is a raw material for an α-olefin oligomer and a hydrogenated product of the α-olefin oligomer used as a base oil, there may be mentioned, for example, 1-pentene, 1-hexene, 1-heptene, 1-octene, 1-nonene, 1-decene, 1-undecene, 1-dodecene, 1-tridecene, 1-tetradecene, 1-pentadecene and the like. These may be used singly or in a combination of two or more kinds thereof.

In the present invention, as the metallocene catalyst used for the oligomerization of α-olefins, there may be mentioned a conventionally known catalyst, for example, a combination of (a) a metallocene complex containing a Group IV element of the periodic table, (b) at least one of (b-1) a compound which is capable of forming an ionic complex by reacting with a metallocene complex of the (a) component or its derivative and (b-2) an aluminoxane, and (c) an organoaluminum compound which is used if desired.

As the a metallocene complex containing a Group IV element of the periodic table of the (a) component, there may be used a complex having a conjugated five-membered ring containing titanium, zirconium or hafnium, preferably zirconium. Here, the conjugated five-membered ring typically includes a complex having a substituted or unsubstituted cyclopentadienyl ligand.

The metallocene complex of the (a) catalyst component includes a conventionally known compound, for example, bis(n-octadecylcyclopentadienyl)zirconium dichloride, bis(trimethylsilylcyclopentadienyl)zirconium dichloride, bis(tetrahydroindenyl)zirconium dichloride, bis[(t-butyldimethylsilyl)cyclopentadienyl]zirconium dichloride, bis(di-t-butylcyclopentadienyl)zirconium dichloride, ethylidenebis(indenyl)zirconium dichloride, biscyclopentadienyl zirconium dichloride, ethylidenebis(tetrahydroindenyl)zirconium dichloride, bis[3,3-(2-methylbenzindenyl)]dimethylsilane-diyl zirconium dichloride, (1,2′-dimethylsilylene)(2,1′-dimethylsilylene)bis(3-trimethylsilylmethylindenyl) zirconium dichloride and the like.

These matallocene complexes may be used singly or in a combination of two or more kinds thereof.

As the compound that is the above-described (b-1) compound capable of forming an ionic complex by reacting with a metallocene complex or its derivative, there may be mentioned, for example, dimethylanilinium tetrakispentafluorophenyl borate, triphenylcarbenium tetrakispentafluorophenyl borate and the like. These may be used singly or in a combination of two or more kinds thereof.

In addition, as the aluminoxane which is a (b-2) compound, there may be mentioned, for example, a chain aluminoxane such as methylaluminoxane, ethylaluminoxane, butylaluminoxane, isobutylaluminoxane and the like and a cyclic aluminoxane. These aluminoxanes may be used singly or in a combination of two or more kinds thereof.

In the present invention, as a (b) catalyst component, there may be used one or more kinds of the (b-1) compounds, one or more kinds of the (b-2) compounds, and in a combination of one or more kinds of the (b-1) compounds and one or more kinds of the (b-2) compounds.

In the case where the (b-1) compound is used as the (b) catalyst component, the ratio of the (a) catalyst component to (b) catalyst component used is in the range of preferably from 10:1 to 1:100 and more preferably from 2:1 to 1:10 by mole ratio. When the ratio deviates from the above range, the catalyst cost per unit mass of polymer becomes high and is not practical. In addition, when the (b-2) compound is used, the ratio is in the range of preferably from 1:1 to 1:1000000 and more preferably from 1:10 to 1-10000 by mole ratio. When the ratio deviates from the above range, the catalyst cost per unit mass of polymer becomes high and is not practical.

Further, as the organoaluminum compound of the (c) catalyst component which is used if desired, there may be mentioned, for example, trimethylaluminum, triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride, ethylaluminum sesquichloride and the like.

These organoaluminum compounds may be used singly or in a combination of two or more kinds thereof.

The ratio of the (a) catalyst component and the (c) catalyst component used is in the range of preferably from 1:1 to 1:10000, more preferably from 1:5 to 1:2000 and further more preferably from 1:10 to 1:1000. The polymerization activity per transition metal can be increased by using the (c) catalyst component, however, when a too large amount of the (c) catalyst component is used, the organoaluminum compound is wasted, and a large amount of it remains in the polymer and is not preferable.

In the case where a catalyst is prepared by using the (a) catalyst component and (b) catalyst component, a contact operation is preferably performed under an inert atmosphere such as a nitrogen gas atmosphere and the like.

In addition, in the case where a catalyst is prepared by using the (a) catalyst component, (b) catalyst component and (c) organoaluminum compound, the (b) catalyst component and (c) organoaluminum compound may be brought into contact in advance, but a sufficiently active catalyst may be obtained by bringing the components (a), (b) and (c) into contact with one another in the presence of an α-olefin.

As the catalyst component, there may be used a catalyst component which was prepared in advance in a catalyst preparation tank, and there may be used a catalyst component prepared in the oligomerization step for the reaction.

The oligomerization of an α-olefin may be carried out by either a batch system or a continuous system. A solvent in the oligomerization is not always required and the oligomerization may be carried out in a suspension, a liquid monomer or an inert solvent. In the case of the oligomerization in a solvent, a liquid organic hydrocarbon, for example, benzene, ethylbenzene, toluene and the like are used. The oligomerization is preferably carried out in a reaction mixture in which the liquid monomer is contained in excess.

The conditions of the oligomerization include a temperature of approximately 15 to 100° C. and a pressure of about atmospheric pressure to about 0.2 MPa. In addition, the ratio of a catalyst to an α-olefin used is such that the molar ratio of an α-olefin/a metallocene complex of (A) component is typically 100 to 10⁶ and preferably 2000 to 10⁵, and the reaction temperature is typically about 10 minutes to about 48 hours.

As an aftertreatment of the oligomerization reaction, firstly, a known deactivation process is performed in which water and alcohols are added to the reaction system to terminate the oligomerization reaction, and then a deashing treatment of the catalyst is performed using an alkali aqueous solution and an alcoholic alkali solution. Subsequently, neutralization-washing, distillation operation and the like are performed, and an olefin isomer by-produced by the oligomerization reaction of an unreacted α-olefin is removed by stripping, and further the α-olefin oligomer having a desired degree of polymerization is isolated.

In this way, the α-olefin oligomer produced by using a metallocene catalyst has a double bond, and especially has a high content of a terminal vinylidene bond.

On the one hand, a hydrogenated product of the α-olefin oligomer may be produced by hydrogenating an α-olefin oligomer having a desired degree of polymerization isolated as in the above by a known method, or may be produced by performing deashing treatment, neutralization process and washing treatment after the oligomerization reaction and then performing the hydrogenation of the α-olefin oligomer without isolation by distillation, and subsequently a hydrogenated product of the α-olefin oligomer having a desired degree of polymerization is isolated by distillation.

The hydrogenation reaction of an α-olefin oligomer is carried out using a known hydrogenation catalyst, for example, a Ni- or Co-based catalyst, a noble metal catalyst such as Pd, Pt and the like, and specifically, a catalyst such as a Ni catalyst supported on diatomaceous earth, a cobalt trisacetylacetonate/organoaluminum catalyst, a palladium catalyst supported on active carbon, a platinum catalyst supported on alumina and the like.

As conditions of the hydrogenation reaction, a temperature range is typically between 150 to 200° C. in the case of a Ni-based catalyst, typically between 50 to 150° C. in the case of a noble metal catalyst such as Pd, Pt and the like, and typically between 20 to 100° C. in the case of a homogeneous catalyst such as a cobalt trisacetylacetonate/organoaluminum catalyst. The hydrogen pressure is from about atmospheric pressure to about 20 Mpa.

When the reaction temperature in each catalyst is within the above range, the reaction proceeds at an appropriate rate, and the generation of an isomer in an oligomer having the same degree of polymerization is suppressed.

When a base oil used for a lubricant composition of the present invention has the above-mentioned properties, the base oil may contain, in addition to at least one of an α-olefin oligomer and a hydrogenated product of the α-olefin oligomer, other base oils at a ratio of 50% by mass or less, preferably 30% by mass or less, more preferably 20% by mass or less, further more preferably 10% by mass or less, but preferably does not contain them.

As the other base oils except for at least one of an α-olefin oligomer and a hydrogenated product of the α-olefin oligomer, there may be mentioned, for example, mineral oil, an ethylene-propylene copolymer, esters (such as monoester, diester, polyol ester and the like), a polyether (such as polyalkylene glycol and the like), an alkylbenzene and the like.

The base oil contains as a main component at least one of an α-olefin oligomer and a hydrogenated product of the α-olefin oligomer, and at least one of the α-olefin oligomer and the hydrogenated product of the α-olefin oligomer have little effect on a resin and elastomer because they are nonpolar compounds.

In the lubricant composition of the present invention, there may be arbitrarily added at least one kind selected from various additives which have been conventionally used, such as, for example, an extreme pressure agent, an oiliness improver, an antioxidant, a rust inhibitor, a metal deactivator, a detergent-dispersant, an antifoaming agent and the like as desired, as long as the object of the present invention is not impaired.

Examples of the extreme pressure agent preferably include phosphoric esters such as phosphate ester, acid phosphate ester, phosphite ester, and acid phosphite ester, amine salts of these phosphoric esters, sulfur-containing extreme pressure agents and the like.

The phosphate ester may be, for example, a triaryl phosphate, a trialkyl phosphate, a trialkylaryl phosphate, a triarylalkyl phosphate, a trialkenyl phosphate and the like. For example, there may be mentioned triphenyl phosphate, tricresyl phosphate, benzyldiphenyl phosphate, ethyldiphenyl phosphate, tributyl phosphate, ethyldibutyl phosphate, cresyldiphenyl phosphate, dicresylphenyl phosphate, ethylphenyldiphenyl phosphate, di(ethylphenyl)phenyl phosphate, propylphenyldiphenyl phosphate, di(propylphenyl)phenyl phosphate, triethylphenyl phosphate, tripropylphenyl phosphate, butylphenyldiphenyl phosphate, di(butylphenyl)phenyl phosphate, tributylphenyl phosphate, trihexyl phosphate, tri(2-ethylhexyl) phosphate, tridecyl phosphate, trilauryl phosphate, trimyristyl phosphate, tripalmityl phosphate, tristearyl phosphate, trioleyl phosphate and the like.

Examples of the acid phosphate ester include 2-ethylhexyl acid phosphate, ethyl acid phosphate, butyl acid phosphate, oleyl acid phosphate, tetracosyl acid phosphate, isodecyl acid phosphate, lauryl acid phosphate, tridecyl acid phosphate, stearyl acid phosphate, isostearyl acid phosphate and the like.

Examples of the phosphite ester include triethyl phosphite, tributyl phosphite, triphenyl phosphite, tricresyl phosphite, tri(nonylphenyl)phosphite, tri(2-ethylhexyl)phosphite, tridecyl phosphite, trilauryl phosphite, triisooctyl phosphite, diphenylisodecyl phosphite, tristearyl phosphite, trioleyl phosphate and the like.

Examples of the acid phosphite ester include dibutyl hydrogen phosphite, dilauryl hydrogen phosphite, dioleyl hydrogen phosphite, distearyl hydrogen phosphite, diphenyl hydrogen phosphate and the like. Among the above phosphoric acid esters, tricresyl phosphate and triphenyl phosphate are preferable.

Amines that form amine salts with these phosphoric acid esters may be a monosubstituted amine, a disubstituted amine or a trisubstituted amine. Examples of the monosubstituted amine include butylamine, pentylamine, hexylamine, cyclohexylamine, octylamine, laurylamine, stearylamine, oleylamine, benzylamine and the like. Examples of the disubstituted amine include dibutylamine, dipentylamine, dihexylamine, dicyclohexylamine, dioctylamine, dilaurylamine, distearylamine, dioleylamine, dibenzylamine, stearylmonoethanolamine, decylmonoethano lamine, hexylmonopropano lamine, benzylmonoethano lamine, phenylmonoethanolamine, tolylmonopropanolamine and the like. Examples of the trisubstituted amine include tributylamine, tripentylamine, trihexylamine, tricyclohexylamine, trioctylamine, trilaurylamine, tristearylamine, trioleylamine, tribenzylamine, dioleylmonoethanolamine, dilaurylmonopropanolamine, dioctylmonoethanolamine, dihexylmonopropanolamine, dibutylmonopropanolamine, oleyldiethanolamine, stearyldipropanolamine, lauryldiethanolamine, octyldipropanolamine, butyldiethanolamine, benzyldiethanolamine, phenyldiethanolamine, tolyldipropanolamine, xylyldiethanolamine, triethanolamine, tripropanolamine and the like.

As for a sulfur-containing extreme pressure agent, any agents having a sulfur atom in the molecule thereof, dissolved or uniformly dispersed in a lubricant base oil, and exhibiting extreme pressure performance and excellent friction characteristics may be used. Examples of these compounds include sulfurized fats and oils, sulfurized fatty acid, sulfurized esters, olefin sulfides, dihydrocarbyl polysulfides, thiadiazole compounds, thiophosphoric esters (thiophosphites and thiophosphates), alkyl thiocarbamoyl compounds, thiocarbamate compounds, thioterpene compounds, dialkyl thiodipropionate compounds and the like. Here, the sulfurized fats and oils may be obtained by a reaction of fats and oils (e.g., lard oil, whale oil, vegetable oil, fish oil or the like) with sulfur or a sulfur-containing compound. The content of sulfur is not particularly limited, but 5 to 30% by mass is generally preferable. As a specific example, a sulfurized lard, a sulfurized rape seed oil, a sulfurized castor oil, a sulfurized soybean oil, a sulfurized rice bran oil and the like are included. As a specific example of the sulfurized fatty acid, sulfurized oleic acid and the like are included. As a specific example of the ester sulfide, include sulfurized methyl oleate, sulfurized octyl ester of rice bran fatty acid, and the like are included.

Examples of the dihydrocarbyl polysulfide preferably include dibenzyl polysulfide, various dinonyl polysulfides, various didodecyl polysulfides, various dibutyl polysulfides, various dioctyl polysulfides, diphenyl polysulfide, dicyclohexyl polysulfide and the like.

Examples of the thiadiazole compound preferably include 2,5-bis(n-hexyldithio)-1,3,4-thiadiazole, 2,5-bis(n-octyldithio)-1,3,4-thiadiazole, 2,5-bis(n-nonyldithio)-1,3,4-thiadiazole, 2,5-bis(1,1,3,3-tetramethylbutyldithio)-1,3,4-thiadiazole, 3,5-bis(n-hexyldithio)-1,2,4-thiadiazole, 3,6-bis(n-octyldithio)-1,2,4-thiadiazole, 3,5-bis(n-nonyldithio)-1,2,4-thiadiazole, 3,5-bis(1,1,3,3-tetramethylbutyldithio)-1,2,4-thiadiazole, 4,5-bis(n-octyldithio)-1,2,3-thiadiazole, 4,5-bis(n-nonyldithio)-1,2,3-thiadiazole, 4,5-bis-(1,1,3,3-tetramethylbutyldithio)-1,2,3-thiadiazole and the like.

Examples of the thiophosphoric ester include alkyl trithiophosphites, aryl or alkylaryl thiophosphates, zinc dilauryldithiophsphate and the like. Among them, lauryl trithiophosphite and triphenyl thiophosphate are particularly preferable.

Examples of the alkylthiocarbamoyl compound preferably include bis(dimethylthiocarbamoyl)monosulfide, bis(dibutylthiocarbamoyl)monosulfide, bis(dimethylthiocarbamoyl)disulfide, bis(dibutylthiocarbamoyl)disulfide, bis(diamylthiocarbamoyl)disulfide, bis(dioctylthiocarbamoyl)disulfide and the like.

In addition, examples of the thiocarbamate compound include zinc dialkyl dithiocarbamate. The thioterpene compound may be, for example, a reaction product of a phosphorus pentasulfide and pinene. Examples of the dialkyl thiodipropionate compound include dilauryl thiopropionate, distearyl thiodipropionate and the like. Among them, the thiadiazole compounds and benzyl sulfide are preferable in view of extreme pressure performance, friction characteristics, stability against thermal oxidation and the like.

The extreme pressure agents may be used singly or in a combination of two or more kinds thereof. The compounding amount of the extreme pressure agent is generally selected in the range of 0.01 to 10% by mass and preferably of 0.05 to 5% by mass, based on the total amount of the lubricant composition.

Examples of the oiliness improver include aliphatic saturated or unsaturated monocarboxylic acids such as stearic acid and oleic acid; polymerized fatty acids such as dimer acid and hydrogenated dimer acid; hydroxyl fatty acid such as ricinoleic acid and 12-hydroxystearic acid; aliphatic saturated or unsaturated monohydric alcohols such as lauryl alcohol and oleyl alcohol; aliphatic saturated or unsaturated monoamines such as stearylamine and oleylamine; aliphatic saturated or unsaturated monocarboxylic amides such as lauramide and oleamide; and the like.

These oiliness improvers may be used singly or in a combination of two or more kinds thereof. The compounding amount of the oiliness improver is generally selected in the range of 0.01 to 10% by mass and preferably of 0.1 to 5% by mass, based on the total weight of the lubricant composition.

Examples of the antioxidant include an amine type antioxidant, a phenolic antioxidant, a sulfur-containing antioxidant and the like.

Examples of the amine type antioxidant include a monoalkyldiphenylamine

20 type antioxidant such as monooctyldiphenylamine and monononyldiphenylamine; a dialkyldiphenylaminc type antioxidant such as 4,4′-dibutyldiphenylamine, 4,4′-dipentyld iphenylamine, 4,4′-dihexyldiphenylamine, 4,4′-diheptyldiphenylamine, 4,4′-dioctyldiphenylamine and 4,4′-dinonyldiphenylamine; a polyalkyldiphenylamine type antioxidant such as tetrabutyldiphenylamine, tetrahexyldiphenylamine, tetraoctyldiphenylamine and tetranonyldiphenylamine; and a naphthylamine type antioxidant such as α-naphthylamine, phenyl-α-naphthylamine, butylphenyl-α-naphthylamine, pentylphenyl-α-naphthylamine, hexylphenyl-α-naphthylamine, heptylphenyl-α-naphthylamine, octylphenyl-α-naphthylamine and nonylphenyl-α-naphthylamine. Among them preferred is the dialkyl diphenylamine type antioxidant.

Examples of the phenolic antioxidant include a monophenol type antioxidant such as 2,6-di-tert-butyl-4-methylphenol and 2,6-di-tert-butyl-4-ethylphenol; and a diphenol type antioxidant such as 4,4′-methylenebis(2,6-di-tert-butylphenol) and 2,2′-methylenebis(4-ethyl-6-tert-butylphenol).

Examples of the sulfur-containing antioxidant include phenothiazine, pentaerythritol-tetrakis(3-lauryl-thiopropionate), bis(3,5-tert-butyl-4-hydroxybenzyl)sulfide, thiodiethylenebis(3-(3,5-di-tert-butyl-4-hydroxyphenyl))propionate, 2,6-di-tert-butyl-4-(4,6-bis(octylthio)-1,3-5-triazine-2-methylamino)phenol and the like.

The above antioxidants may be used singly or in a combination of two or more kinds thereof. In addition, the compounding amount of the antioxidant is generally selected in the range of 0.01 to 10% by mass and preferably of 0.03 to 5% by mass, based on the total amount of the lubricant composition.

Examples of the rust inhibitor include alkyl and alkenyl succinate derivatives such as dodecenyl succinate half ester, octadecenyl succinic anhydride and dodecenylsuccinamide; polyhydric alcohol partial esters such as sorbitan monooleate, glycerin monooleate and pentaerythritol monooleate; amines such as rosin amines and N-oleylsarcosine; dialkyl phosphite amine salts; and the like. These rust inhibitors may be used singly or in a combination of two or more kinds thereof.

The compounding amount of the rust inhibitor is preferably in the range of 0.01 to 5% by mass and particularly preferably of 0.05 to 2% by mass, based on the total amount of the lubricant composition.

As the metal deactivator, there may be used, for example, benzotriazole-based compounds, thiadiazole-based compounds, gallic acid ester-based compounds and the like.

The compounding amount of the metal deactivator is preferably in the range of 0.01 to 0.4% by mass and particularly preferably of 0.01 to 0.2% by mass, based on the total amount of the lubricant composition.

As the detergent-dispersant, there may be mentioned metal-based detergents such as alkaline earth metal sulfonates, alkaline earth metal phenates, alkaline earth metal salicylates and alkaline earth metal phosphonates, and ashless dispersants such as alkenyl succinimide, benzylamine, alkylpolyamine and alkenyl succinate. These detergent-dispersants may be used singly or in a combination of two or more kinds thereof. The compounding amount of the detergent-dispersant is preferably in the range of typically from 0.1 to 30% by mass and preferably of from 0.5 to 10% by mass, based on the total amount of the lubricant composition.

As the antifoaming agent, a liquid silicone is preferable, and methylsilicone, fluorosilicone and polyacrylate may be used.

The compounding amount of the antifoaming agent is preferably in the range of 0.0005 to 0.02% by mass based on the total amount of the lubricant composition.

A lubricant composition of the present invention is especially preferable as a bearing oil, which contains a base oil containing as a main component an α-olefin oligomer or its hydrogenated product that have little effect on a resin and elastomer because it is a nonpolar compound, in addition to having an extremely small amount of evaporation and a high flash point despite a low viscosity, and is used for, for example, oil hydraulics, turbines, machine tools, bearings, gears, metal processing and the like.

The present invention also provides the above-mentioned bearing oil and bearings using thereof. The bearings may preferably include fluid dynamic bearings, oil retaining bearings, oil retaining bearings on which dynamic grooves are formed, and the like.

The rotation speed of spindle motors used in electric equipments, especially CD, DVD, HDD, polygon scanner and the like increases year by year, and a high speed rotation of 10000 rpm or more has been currently required.

Conventionally, rolling bearings represented by ball bearings have been used in these spindle motors, however, noncontact fluid dynamic bearings and low cost sintered oil retaining bearings have been used from the viewpoint of performance and cost. The performance (mainly rotational torque) of these fluid dynamic bearings and sintered oil retaining bearings at high speed rotation is frequently determined by the viscosity of a lubricant used, and as the viscosity is decreased, the rotational torque at high speed rotation tends to decrease.

Once these lubricants are enclosed in a bearing mechanism, the lubricity is required to be maintained for life without resupplies, and thus the evaporation loss and decomposition loss of a lubricant should be avoided as much as possible.

Since a lubricant composition of the present invention has characteristics in which the amount of evaporation is extremely small while having a low viscosity, it is extremely useful as a lubricant for the above-mentioned fluid dynamic bearings and sintered oil retaining bearings.

Incidentally, for an HDD spindle motor used in a high-accuracy and high-definition recording instrument, much higher rotational accuracy and higher credibility is required. Therefore, it was not possible to use sintered oil retaining bearings having a certain clearance for the rotational axis and causing uneven rotation.

However, because the sintered oil retaining bearings have remarkably excellent workability and can be produced on a large scale, they can be put on the market at a lower price as compared with rolling bearings and fluid dynamic bearings. For this reason, the application of the sintered oil retaining bearings has been demanded even in the field of HDD of which cost reduction is under way.

To address this problem, there have been developed, for example, a specific mechanism in which a prescribed-directional lateral pressure is applied to a sintered oil retaining bearing so as to reduce as much as possible the deflection of the rotational axis of the motor while retaining inherent characteristics of the sintered oil retaining bearings, and a dynamic pressure type sintered oil retaining bearing unit provided with a dynamic pressure type sintered oil retaining bearing that is made of a sintered metal, the bearing body of which is provided with a bearing surface that faces an outer periphery of the axis through a bearing gap, is impregnated with a lubricant or lubricant grease, and contactlessly supports the axis by a dynamic pressure action generated by the relative rotation of the axis and the bearing body, a housing one end of which is open and houses the dynamic pressure type sintered oil retaining bearing inside the inner diameter portion, and a thrust bearing that is fixed at the other end of the housing and supports the axis in the thrust direction, where dynamic grooves are formed on the surface of the thrust bearing by press molding in the dynamic pressure type sintered oil retaining bearing unit.

The present invention further provides a rotary apparatus equipped with the above-mentioned bearing unit having the bearings.

As an example of the rotary apparatus, there may be mentioned a pressurized motor in which means is provided to apply a lateral pressure in a specific direction to a motor shaft supported by oil retaining bearings formed of compacted and sintered metal powder so that one of the stacked cores which are fixed at symmetrical positions relative to the motor shaft is displaced in the direction of the motor shaft and the oil retaining bearings are impregnated with a lubricant composition of the present invention.

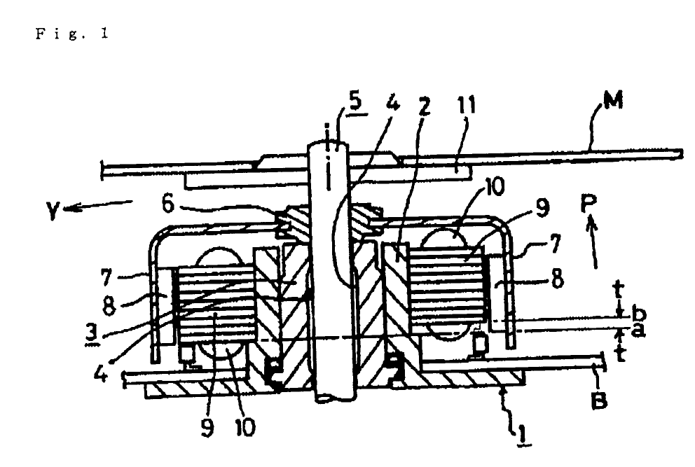

Next, the above-described pressurized motor will be described with reference to the accompanying figures. FIG. 1 is an enlarged cross-sectional view illustrating an example of a spindle motor. The reference numeral 1 designates a housing holder, 3 designates a bearing and 5 designates a motor shaft. The housing holder 1 is mounted on a base B and has a cylindrical section 2. The cylindrical section 2 has an outer periphery provided with stacked cores 9 each having a coil 10 wound therearound.

The bearing 3 is produced by compacting and molding a powdered metal such as copper into a shape capable of being accommodated in the housing holder 1, and then by sintering and further by impregnating with a lubricant composition of the present invention. The bearing 3 is provided with an inside relief 4 at a middle portion of its shaft hole and therefore, is a so-called center free type with an inside relief. The motor shaft 5 is supported at opposite end portions in the longitudinal direction of the bearing 3.

The motor shaft 5 is made of a metal rod having such an outer diameter that the shaft is capable of being received in the bearing 3. Integrally mounted, through a retaining member 6, to a portion near an edge positioned at an output side of the motor is a rotor 7 which covers the laminate cores 9 and the coils 10 and is provided with a magnet 8 on its inner periphery at a position facing each of the laminate cores 9. A hub configured to secure a rotation medium M of HDD is also integrally attached to an edge portion of the motor shaft 5.

In addition, means is provided to apply a lateral pressure in a specific direction to the motor shaft 5 (closer to the turn table 11) received in the oil retaining bearing 3 formed of compacted and sintered metal powder so that one of the stacked cores 9 which are fixed at symmetrical positions relative to the motor shaft 5 is displaced by a distance t-t from the position indicated by the line “a” to the position indicated by the line “b”. As a consequence of the inclination of the stacked cores 9, the rotor 7 rotating at a high speed is always biased in the direction indicated by the arrow P. Therefore, a lateral pressure is always applied to the motor shaft 5 in a specific direction (in the direction of the arrow Y).

By applying a lateral pressure in the specific direction to the motor shaft, the deflection of the shaft for the oil retaining bearing formed of compacted and sintered metal powder may be suppressed.

### EXAMPLES

Next, the present invention will be explained in further detail with reference to Examples, but the present invention is no way limited by these examples.

In addition, the kinematic viscosity, the flash point of a base oil and the residual amount of a thin film of a lubricant composition were measured in accordance with the following methods.

### (1) Kinematic Viscosity of a Base Oil

The kinematic viscosity at 40° C. was measured in accordance with JIS K 2283.

### (2) Flash Point of a Base Oil

The flash point was measured by a COC method in accordance with JIS K 2265.

### (3) Residual Amount of a Thin Film

A sample of 10 g was weighed and the residual amount at 140° C. for 480 hours was measured using a vessel and a constant-temperature air bath described in the thermal stability test of a lubricating oil according to JIS K 2540. The amount was represented by a percentage and recorded as the residual oil rate.

### Examples 1 to 6 and Comparative Examples 1 to 4

Lubricant compositions having the compositions shown in Table 1 were prepared and the residual amount of a thin film was measured. The results are shown in Table 1. In addition, the measured results of the kinematic viscosity at 40° C. and the flash point of the base oils used are collectively shown in table 1.

### Production Example 1

### Production of a Hydrogenated Product of a 1-Decene Oligomer

(a) Oligoemrization of Decene

Into a three-necked flask having an internal volume of 5 liters, 4 liters (21.4 mol) of decene monomer (produced by Idemitsu Kosan Co., Ltd.: Linealene 10) was charged under an inert gas flow, and further biscyclopentadienyl zirconium dichloride (complex mass, 1168 mg: 4 mmol) dissolved in toluene and methylalmoxane (40 mmol in terms of aluminum) dissolved in toluene were added. The resultant mixture was maintained at 40° C. and stirred for 20 hours, and then 20 ml of methanol was added to terminate the oligomerization reaction. Subsequently, the reaction mixture was taken out of the autoclave. To the mixture was added 4 liters of a 5 mol/L aqueous sodium hydroxide solution and the resultant mixture was forcibly stirred at room temperature for 4 hours, and then the separating operation was performed. The upper organic layer was taken out and then unreacted decene and a decene isomer which is a side-reaction product were removed by stripping.

(b) Hydrogenation of a Decene Oligomer

Into an autoclave having an internal volume of 5 liters, 3 liters of the decene oligomer produced in (a) was charged under nitrogen gas flow, and cobalt trisacetylacetonate (catalyst weight: 3.0 g) dissolved in toluene and triisobutylaluminum (30 mmol) diluted with toluene were added. After the addition, the atmosphere of the system was replaced with hydrogen twice and the reaction mixture was heated at the reaction temperature of 80° C. under a hydrogen pressure of 0.9 MPa. The hydrogenation immediately proceeded, accompanied by heat generation. The reaction temperature was lowered at four hours after the initiation of the reaction to terminate the reaction. Thereafter, the reaction system was depressurized and the contents were taken out. The reaction product then was subjected to simple distillation to separate a fraction (a hydrogenated product of a trimer of 1-decene) at a distillation temperature of 240 to 270° C. and at a pressure of 530 Pa.

TABLE 1

| | | | Example 1 | Example 2 | Example 3 | Example 4 | Example 5 |
|---|---|---|---|---|---|---|---|
| | | | Kind of oil applied | | | | |
| | | | | | | | Fluid dynamic |
| | | | Hydraulic | | | | bearing, oil |
| | | | oil, Turbine | | | Machine | retaining |
| | | | oil | Bearing oil | Gear oil | tool oil | bearing oil |
| Composition | Base Oil | Acid catalyst | | | | | |
| of lubricant | | PAO1(Conventional PAO) ¹⁾ | | | | | |
| composition | | Acid catalyst | | | | | |
| (% by mass) | | PAO2(Conventional PAO) ²⁾ | | | | | |
| | | Acid catalyst PAO3 ³⁾ | | | | | |
| | | Metallocene PAO ⁴⁾ | Residue | Residue | Residue | Residue | Residue |
| | Additive | Phenol-based antioxidant ⁵⁾ | 0.5 | 0.5 | 0.5 | 0.5 | |
| | | Amine-based antioxidant 1 ⁶⁾ | 0.2 | 0.2 | 0.2 | | |
| | | Amine-based antioxidant 2 ⁷⁾ | | | | | 0.5 |
| | | Phosphate ester 1 ⁸⁾ | 1 | | | | |
| | | Phosphate ester 2 ⁹⁾ | | | | 0.5 | 1 |
| | | Phosphate ester amine salt ¹⁰⁾ | | | 1 | | |
| | | Sulfur-based extreme pressure | | 1 | 1 | | |
| | | agent 1 ¹¹⁾ | | | | | |
| | | Sulfur-based extreme pressure | | | | 1 | |
| | | agent 2 ¹²⁾ | | | | | |
| | | Metal-based extreme pressure | | | | | |
| | | agent 1 ¹³⁾ | | | | | |
| | | Rust inhibitor ¹⁴⁾ | 0.05 | 0.05 | 0.05 | 0.05 | 0.05 |
| | | Metal-deactivating agent ¹⁵⁾ | 0.05 | 0.05 | 0.05 | 0.05 | 0.05 |
| | | Antifoaming agent ¹⁶⁾ | 0.01 | 0.01 | 0.01 | 0.01 | 0.01 |

| | | | | | | |
|---|---|---|---|---|---|---|
| Properties of base oil | Kinematic viscosity at 40° C. | 13.65 | 13.67 | 13.71 | 13.78 | 13.74 |
| | (mm²/s) | | | | | |
| | Flash point (C.O.C) | 231 | 234 | 233 | 231 | 234 |
| | Value of [49 × 1 nγ + 90] | 218.1 | 218.1 | 218.3 | 218.5 | 218.4 |

| | | | | | |
|---|---|---|---|---|---|
| Residual amount of a thin film of the composition | 93.9 | 92.5 | 92.8 | 92.1 | 93.5 |
| (% by mass) | | | | | |

| | | | | Comparative | Comparative | Comparative | Comparative |
|---|---|---|---|---|---|---|---|
| | | | Example 6 | Example 1 | Example 2 | Example 3 | Example 4 |
| | | | Kind of oil applied | | | | |
| | | | Metal | | | | |
| | | | processing oil | | | | |
| Composition | Base Oil | Acid catalyst | | | 30 | Residue | |
| of lubricant | | PAO1(Conventional PAO) ¹⁾ | | | | | |
| composition | | Acid catalyst | | Residue | Residue | | |
| (% by mass) | | PAO2(Conventional PAO) ²⁾ | | | | | |
| | | Acid catalyst PAO3 3⁾ | | | | | Residue |
| | | Metallocene PAO ⁴⁾ | 100 | | | | |
| | Additive | Phenol-based antioxidant ⁵⁾ | | | | | |
| | | Amine-based antioxidant 1 ⁶⁾ | | | | | |
| | | Amine-based antioxidant 2 ⁷⁾ | | 0.5 | 0.5 | 0.5 | 0.5 |
| | | Phosphate ester 1 ⁸⁾ | | | | | |
| | | Phosphate ester 2 ⁹⁾ | | 1 | 1 | 1 | 1 |
| | | Phosphate ester amine salt ¹⁰⁾ | | | | | |
| | | Sulfur-based extreme pressure | | | | | |
| | | agent 1 ¹¹⁾ | | | | | |
| | | Sulfur-based extreme pressure | | | | | |
| | | agent 2 ¹²⁾ | | | | | |
| | | Metal-based extreme pressure | | | | | |
| | | agent 1 ¹³⁾ | | | | | |
| | | Rust inhibitor ¹⁴⁾ | | 0.05 | 0.05 | 0.05 | 0.05 |
| | | Metal-deactivating agent ¹⁵⁾ | | 0.05 | 0.05 | 0.05 | 0.05 |
| | | Antifoaming agent ¹⁶⁾ | | 0.01 | 0.01 | 0.01 | 0.01 |

| | | | | | | |
|---|---|---|---|---|---|---|
| Properties of base oil | Kinematic viscosity at 40° C. | 13.61 | 17.3 | 12.1 | 5.2 | 14.5 |
| | (mm²/s) | | | | | |
| | Flash point (C.O.C) | 232 | 222 | 198 | 158 *⁾ | 220 |
| | Value of [49 × 1 nγ + 90] | 217.9 | 229.7 | 212.2 | 170.8 | 221.0 |

| | | | | | |
|---|---|---|---|---|---|
| Residual amount of a thin film of the composition | 94.1 | 92.9 | 63.8 | 1.7 | 82 |
| (% by mass) | | | | | |

*⁾ Flash point by a PM method
[Notes]
¹⁾ Poly-alpha-olefin which is a 1-decene dimer by a conventional method (produced by BP Chemicals Ltd, trade name “DURASYN-162”)
²⁾ Poly-alpha-olefin which is a 1-decene trimer by a conventional method (produced by BP Chemicals Ltd, trade name “DURASYN-164”)
³⁾ Poly-alpha-olefin which is a 1-tetradecene dimer, synthesized using a BF₃ catalyst by a conventional method
⁴⁾ Hydrogenated product of a 1-decene trimer synthesized using a metallocene catalyst obtained in Production Example 1
⁵⁾ Di-t-butyl-p-cresol
⁶⁾ Dioctyldiphenylamine
⁷⁾ N-(p-octylphenyl)-1-naphthylamine
⁸⁾ Tricresylphosphate
⁹⁾ Dioleyl hydrogen phosphite
¹⁰⁾ Di(mono)methyl acid phosphate amine salt
¹¹⁾ Dioctyl disulfide
¹²⁾ Sulfurized fats and oils
¹³⁾ Zinc dithiophosphate
¹⁴⁾ Alkenyl succinate
¹⁵⁾ Benzotriazole
¹⁶⁾ Dimethylpolysiloxane

As understood from Table 1, a lubricant composition of the present invention (Examples 1 to 6) is characterized in that the base oil used satisfies the above-mentioned equation (I), has a low kinematic viscosity at 40° C. and a high residual amount of a thin film (residual oil rate) (the amount of evaporation is small).

### INDUSTRIAL APPLICABILITY

A lubricant composition of the present invention has characteristics such as a small amount of evaporation and a high flash point despite a low viscosity and is used for oil hydraulics, turbines, machine tools, bearings, gears, metal processing and the like and is especially preferable as a bearing oil.

1: A lubricant composition comprising a base oil, which comprises 50% by mass or more of at least one of an α-olefin oligomer and a hydrogenated product of an α-olefin oligomer and having a kinematic viscosity and a flash point satisfying the following equation (I):
Flash point (° C.)≧49×ln γ+90 (I)
wherein γ is a kinematic viscosity (mm²/s) at 40° C.

2: The lubricant composition according claim 1, wherein the α-olefin oligomer has a structure represented by the following general formula (II): 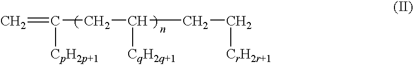
wherein p, q and r are each independently an integer of 0 to 18; n is an integer of 0 to 8; when n is 2 or more, q may be the same or different for every repeating unit; and a value of p+n×(2+q)+r is 12 to 36, and
the hydrogenated product of an α-olefin oligomer has a structure represented by the following general formula (III): 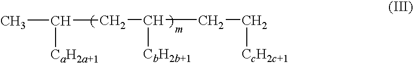
wherein a, b and c are each independently an integer of 0 to 18; m is an integer of 0 to 8; when m is 2 or more, b may be the same or different for every repeating unit; and a value of a+m×(2+b)+c is 12 to 36.

3: The lubricant composition according claim 1, wherein the base oil has a kinematic viscosity of 8 to 17 mm²/s at 40° C.

4: The lubricant composition according claim 1, wherein the α-olefin oligomer is
an oligomer having 24 to 30 carbon atoms obtained by using a metallocene catalyst and
the hydrogenated product of an α-olefin oligomer is an oligomer obtained by hydrogenating an α-olefin oligomer having 24 to 30 carbon atoms obtained by using a metallocene catalyst.

5: The lubricant composition according claim 1, further comprising at least one member selected from the group consisting of an extreme pressure agent, an oiliness improver, an antioxidant, a rust inhibitor, a metal deactivator, a detergent-dispersant, and an antifoaming agent.

6: The lubricant composition according claim 1, wherein the lubricant composition is used for oil hydraulics, a turbine, a machine tool, a bearing, a gear, or metal processing.

7: A bearing oil comprising the lubricant composition according to claim 1.

8: A bearing comprising the bearing oil according to claim 7.

9: The bearing according to claim 8, wherein the bearing is a fluid dynamic bearing, an oil retaining bearing, or an oil retaining bearing provided with a dynamic groove.

10. A rotary apparatus comprising a bearing unit having the bearing according to claim 8.
